(19) United States
(12) Patent Application Publication
(10) Pub. No.: US 2009/0276270 A1
(43) Pub. Date: Nov. 5, 2009

(54) SYSTEM CONFIGURATION APPLICATION AND USER INTERFACE

(75) Inventor: Hemant Somani Karnataka, Hales Corners, WI (US)

Correspondence Address: TUROCY & WATSON, LLP;ATTENTION: HEATHER HOLMES, 127 Public Square, 57th Floor, Key Tower, Cleveland, OH, 44114, US

(73) Assignee: Rockwell Automation Technologies, Inc., Mayfield Heights, OH (US)

(21) Appl. No.: 12/240,674

(22) Filed: Sep. 29, 2008

Related U.S. Application Data
(60) Provisional application No. 61/049,996, filed on May 2, 2008.

(51) Int. Cl. G06Q 10/00; G06Q 50/00; G06Q 30/00; G06F 7/00; G06F 19/00; G06F 17/30

(52) U.S. Cl. 705/8; 705/7; 705/28; 705/26; 705/29; 707/101; 700/107; 707/E17.05; 707/E17.124

(57) ABSTRACT

An interface tool is provided. The interface includes an aggregator that collects input data from a user and transforms the input data to a form suitable by a business processing system. A format component receives output data from the business processing system and transforms the output data to a form suitable by a user.

### CROSS-REFERENCE TO RELATED APPLICATIONS

This application is a continuation of U.S. Provisional Patent Application Ser. No. 61/049,996, filed May 2, 2008 and entitled SYSTEM CONFIGURATION APPLICATION AND USER INTERFACE, the entirety of which is incorporated herein by reference.

### TECHNICAL FIELD

The claimed subject matter relates generally to industrial control systems and more particularly to an interface that collects and processes information for higher level business applications while mitigating the need to alter software components within the applications.

### BACKGROUND

Systems, Applications and Products in Data Processing software is referred to under the acronym SAP. Over the years, SAP and associated Enterprise Resource Planning (ERP) has grown and evolved to become the world premier provider of client/server business solutions for which it is so well known today. For instance, SAP enterprise applications for open client/server systems have established new standards for providing business information management solutions. The main advantage of using SAP as a company ERP system is that SAP provides a very high level of integration among its individual applications which facilitate consistency of data throughout the system and the company itself.

In one aspect, some companies employ SAP's Variant Configurator (VC) and Internet Pricing Configurator (IPC) as part of a Global SAP Deployment. Thus, products can be specified utilizing tools to assist the user in configuring and selecting products. These tools assist with both standard products and system products. Generally, SAP VC and IPC have been successfully deployed for the Product Configuration domain such as in the specification of Bill of Materials for control systems. However, the System Configurator has requirements for assembling or collecting various components or products based on specific criteria and requires validating them as a complete system solution. Following are some of the typical requirements of system configuration:

In system configuration various components are inter-connected in some logical order based on certain business and technical rules; The connections between the various components are dynamic in nature; In system configuration, normally, first lowest level “configurable” components (e.g., Units in a motor control center (MCC)) are configured and then upper level structure is inferred or developed based on placement/slotting rules. In the configuration domain this is referred to as bottom-up approach; and Run time copy and delete operation of components.

In order to meet above system configuration requirements, SAP's standard VC and IPC functionalities are not sufficient. In standard VC for example, it is necessary to define connection between components at design time so it is not possible to define those connections dynamically at run time. In standard VC, it is necessary to first configure top level element or component before configuring lower level components i.e., top-to-bottom approach. Also, run time copy and deleting of components are not straight forward.

Typically, SAP's Advance Mode has solutions for all the above requirements. Advance Mode supports features such as ADT (Abstract Data Type), dynamic instantiation of system components and aggregation rules which are very much required in order to achieve the above requirements. In view of SAP's standard functionality, it may be desirable to implement system configuration in SAP using the “Advanced Mode” feature of VC. This feature is located in the IPC of SAP but is not supported with the standard functionality. Advance Mode modeling, when used for system configuration, requires the use of a sales-order bill of material (BOM), where the Sale Order BOM is then required to be mapped to an engineering control center (ECC) using SAP Custom Development. An SAP custom development group recommends the use of Advanced Mode for system configuration which requires core modifications to SAP for integration of Advanced Mode functionality with other parts of the ERP system. This requires a one time development, on-going maintenance, and support including testing during upgrades. It also requires the development of a new competency for Advanced Mode modeling which it currently does not possess. It is exceedingly difficult to facilitate changes within the SAP system while meeting other manufacturing goals in a timely manner.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

An interface tool is provided that interacts with a higher level business processing system in a format suitable for the system yet provides the functionality desired by the user of such systems. The interface tool collects or aggregates user inputs for the business processing system and outputs commands and other data that is in a form to be readily processed by the system. After system processing of the user inputs, the interface tool receives processed output from the business system and transforms the received output in a form suitable for the user. Thus, the interface tool mitigates having to develop custom modifications within the business processing system by abstracting data and other commands to a form that is desired by the user. At one end of the interface, the user interacts with the tool in a form suitable for the respective interface. This interaction is abstracted and transformed into a subsequent form that is suitable for processing by the business processing system. After processing, data is returned to the user by subsequent transform of the nuances of the business system within the interface tool to the ultimate form desired by the user. Such transforms and abstractions mitigate the need to write custom software to generate the forms within the business processing system.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating an interface tool for an industrial manufacturing system.

FIG. 2 is a diagram that illustrates an example interface model for an industrial manufacturing system.

FIG. 3 is a diagram of example interface for an industrial manufacturing system.

FIG. 4 is a flow diagram illustrating a data transformation process.

FIG. 5 is a diagram of example interface for an industrial manufacturing system illustrating automatic layout features.

FIG. 6 is a diagram of example interface for an industrial manufacturing system illustrating a project interface.

FIG. 7 is a diagram of example interface for an industrial manufacturing system illustrating a unit specification interface.

FIG. 8 is a diagram of example interface for an industrial manufacturing system illustrating a module specification interface.

FIG. 9 is a diagram of example interface for an industrial manufacturing system illustrating tools options.

FIG. 10 is a diagram of example interface for an industrial manufacturing system illustrating a business interface screen.

### DETAILED DESCRIPTION

An industrial control interface is provided to interact with higher-level business systems. In one aspect, an interface tool is provided. The interface includes an aggregator that collects input data from a user and transforms the input data to a form suitable by a business processing system. A format component receives output data from the business processing system and transforms the output data to a form suitable by a user.

It is noted that as used in this application, terms such as “component,” “interface,” “tool,” and the like are intended to refer to a computer-related entity, either hardware, a combination of hardware and software, software, or software in execution as applied to an automation system for industrial control. For example, a component may be, but is not limited to being, a process running on a processor, a processor, an object, an executable, a thread of execution, a program and a computer. By way of illustration, both an application running on a server and the server can be components. One or more components may reside within a process and/or thread of execution and a component may be localized on one computer and/or distributed between two or more computers, industrial controllers, and/or modules communicating therewith.

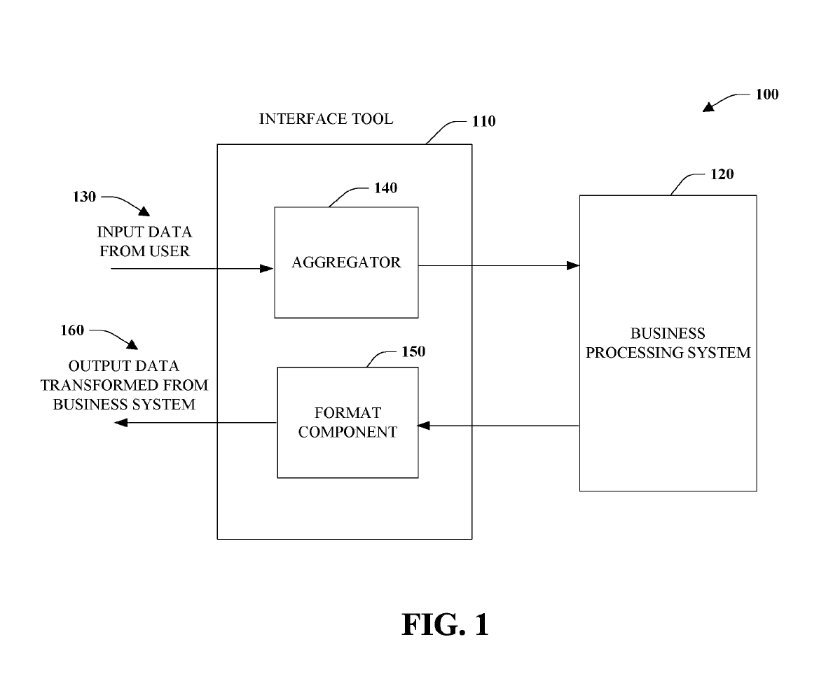

Referring initially to FIG. 1, an industrial manufacturing system 100 and interface tool 110 is illustrated. The interface tool 110 interacts with a higher level business processing system 120 in a format suitable for the system yet provides the functionality desired by the user of such systems. The interface tool 110 collects or aggregates user inputs 130 for the business processing system 120 via an aggregator 140 and outputs commands and other data that is in a form to be readily processed by the system 120. After system processing of the user inputs 130, the interface tool 110 receives processed output from the business system 120 and transforms the received output in a form suitable for the user. A format component 150 transforms data from the business processing system 120 and provides output to the user at 160.

In one example that is described in more detail below, input 130 from the user may include cabinet specifications for localized control centers, where each cabinet is designed to provide some aspect of an overall control system. The input might include a tree structure that represents a bill of material (BOM) structure that shows higher level models in the cabinet and the components that occupy such modules as members of the respective tree structure. For example, two controller racks may be specified for a cabinet housing the racks, where components of each of the racks are identified as the modules that occupy the racks. The modules can include controllers, I/O modules, communications modules, and so forth. Upon entry of the racks and their respective modules via the interface tool 110, the user would see a tree structure highlighting the two racks as nodes of the tree and linked visually to the related modules specified for the racks. In prior systems, the business processing system 120 was not equipped to process such linked tree structures. According to this aspect, the aggregator 140 processes the linked structure preferred by the user and breaks the structure down to individual components required by the business processing system 120. The business processing system 120 then processes the components that can be customer orders for the components in an individual manner and outputs results to the format component 150, which provides data from the business processing system in a form suitable to the user (e.g., formatted data showing order in a linked tree structure). As can be appreciated, substantially any transform or formatting of industrial control specifications (or other data) performed by an interface tool 110 and business processing system 120 is in accordance with the claimed subject matter.

The interface tool 110 mitigates having to develop custom modifications within the business processing system 120 by abstracting data and other commands to a form that is desired by the user at 160. At one end of the interface at 130, the user interacts with the tool 110 in a form suitable for the respective interface. This interaction is abstracted and transformed into a subsequent form via the aggregator 140 that is suitable for processing by the business processing system 120. After processing, data is returned to the user by subsequent transform of the nuances of the business system 120 within the interface tool via the format component 150. Such transforms and abstractions mitigate the need to write custom software to generate the forms within the business processing system 120. It is noted that the business processing system 120 can be substantially any type of manufacturing software system including SAP systems, ERP systems, MES systems (Manufacturing Execution Systems), Oracle Database systems, and so forth.

In one aspect, in a System Configuration, it is not possible to define all the elements of a Super bill of materials (BOM), since the BOM is dynamic in nature and its final configuration and limits are not defined until the configuration is completed by the user. Therefore, it is not possible to define all of the possible options for a complete manufacturing solution such as a motor control center (MCC) using a BOM to define modules and other components of the center. It is to be appreciated that substantially any type of control or industrial product can be specified in such manner.

Generally, it is useful to define the relationships of different components within the MCC (or other manufacturing item) at different levels in the Variant Configurator (VC) models (e.g., define tree or hierarchical relationships). For example, relationship of the unit to the cabinet, cabinet to the shipping block and shipping block to the MCC and so forth. Relationships can be required to be defined in the model which is possible in the Advanced Mode Model of the business processing system 120 and not in the standard VC. If both assumptions are true, it would appear that using the Advance Mode was the likely option to achieve a system configuration solution.

Upon analyzing the current system configurators available in SAP, it was discovered that the maximal size of a configured solution was not unlimited and that a maximum limit could be established. As a fact, the current software has a defined maximum limit. Since it is possible to define a “practical” limit to the levels of configuration and to the number of instances at each level of system configuration it is possible to aggregate solutions and transforms data for the respective business processing system 120.

While analyzing the System Configuration problem and studying various components of the System Configuration solution including the user interface, VC modeling and Sales Order BOM, the following solution was provided to link the relationships for the models at the user interface (UI) level rather than the model level and a prototype was constructed to demonstrate the feature.

In both the Advanced Mode solution where custom code is generated and in the system 100 solution it was recognized that System Configuration can not exist without a powerful User Interface 110. Based on this fact, a solution was provided in which individual “lower” level configurable components (e.g., units in an MCC) were identified and modeled independently in the standard VC. Also, multilevel relationships with “practical limits on instances” of different system components were modeled in the VC using standard VC modeling methods. Practical limits on instances did not apply to the lowest level of units.

It is noted that the business processing system 120 can be substantially any type of manufacturing software system including SAP systems, ERP systems, MES systems (Manufacturing Execution Systems), Material Resource Planning (MRP) systems, Customer Relationship Management (CRM) systems, Oracle Database systems, other database systems, and so forth. The following provides a brief description of each of these respective examples. It is to be appreciated that the claimed subject matter is not limited to these respective examples.

SAP ERP is one of five major applications in SAP's Business applications. The other four applications are:

Customer relationship management (CRM)—helps companies acquire and retain customers, gain deep marketing and customer insight, and align organization on customer-focused strategies.

Product lifecycle management (PLM)—helps manufacturers with a single source of all product-related information for collaborating with business partners and supporting product lines.

Supply chain management (SCM)—helps companies enhance operational flexibility across global enterprises and provide real-time visibility for customers and suppliers.

Supplier relationship management (SRM)—customers can collaborate closely with suppliers and integrate sourcing processes with applications throughout the enterprise to enhance transparency and lower costs.

Other product offerings include: the NetWeaver platform, Governance, Risk and Compliance (GRC) solutions, Duet (joint offering with Microsoft), Performance Management solutions and RFID.

With respect to CRM software, CRM software is used to support processes, storing information on current and prospective customers. Information in the system can be accessed and entered by employees in different departments, such as sales, marketing, customer service, training, professional development, performance management, human resource development, and compensation. Details on any customer contacts can also be stored in the system. The rationale behind this approach is to improve services provided directly to customers and to use the information in the system for targeted marketing and sales purposes.

Regarding PLM software, this includes the process of managing the entire lifecycle of a product from its conception, through design and manufacture, to service and disposal. It is one of the four aspects of a corporation's information technology structure. All companies need to manage communications and information with their customers (CRM—Customer Relationship Management), their suppliers (SCM—Supply Chain Management), their resources within the enterprise (ERP—Enterprise Resource Planning) and their planning (SDLC—Systems Development Life Cycle. In addition, manufacturing engineering companies must also develop, describe, manage and communicate information about their products which can be supported by the business processing system 120.

Regarding SCM software, Supply chain management (SCM) is the process of planning, implementing and controlling the operations of the supply chain as efficiently as possible. Supply Chain Management spans all movement and storage of raw materials, work-in-process inventory, and finished goods from point-of-origin to point-of-consumption. Supply Chain Management encompasses the planning and management of all activities involved in sourcing, procurement, conversion, and logistics management activities. Importantly, it also includes coordination and collaboration with channel partners, which can be suppliers, intermediaries, third-party service providers, and customers. In essence, Supply Chain Management integrates supply and demand management within and across companies. More recently, the loosely coupled, self-organizing network of businesses that cooperates to provide product and service offerings has been called the Extended Enterprise. Supply Chain Management can also refer to Supply chain management software which are tools or modules used in executing supply chain transactions, managing supplier relationships and controlling associated business processes.

Other business processing systems 120 can also include MES and MRP systems. A Manufacturing Execution System (MES) is system that companies can use to measure and control production activities with the aim of increasing productivity and improving quality. The MES is a shop floor control system and software which includes either manual or automatic labor and production reporting as well as on-line inquiries and links to tasks that take place on the production floor. The MES includes links to work orders, receipt of goods, shipping, quality control, maintenance, scheduling, and other related tasks. A Material Requirements Planning (MRP) system is a software-based production planning and inventory control system used to manage manufacturing processes. An MRP system is intended to simultaneously meet three objectives: Ensure materials and products are available for production and delivery to customer; Maintain the lowest possible level of inventory; and Plan manufacturing activities, delivery schedules and purchasing activities. As noted previously, substantially any system or software that can receive manufacturing or industrial specifications can be employed as the business processing system 120.

Still yet other type business processing components can include database systems that house and process industrial manufacturing data. Various techniques are used to model data structures for industrial automation systems. Most database systems are built around one particular data model, although it is increasingly common for products to offer support for more than one model. For any one logical model, various physical implementations may be possible, and most products will offer the user some level of control in tuning the physical implementation, since the choices that are made have a significant effect on performance. In a hierarchical model, data is organized into an inverted tree-like structure (e.g., BOM tree), implying a multiple downward link in each node to describe the nesting, and a sort field to maintain records in a particular order in each same-level list. This structure arranges the various data elements in a hierarchy and helps to establish logical relationships among data elements of multiple files. Each unit in the model is a record which is also known as a node. In such a model, each record on one level can be related to multiple records on the next lower level. A record that has subsidiary records is referred to as a parent and the subsidiary records are referred to as children. Data elements in this model are well suited for one-to-many relationships with other data elements in the database.

Another type model includes the relational model. The basic data structure of the relational model is a table where information about a particular entity (e.g., units, modules) is represented in columns and rows. The columns enumerate the various attributes of an entity (e.g., employee name, address, phone number). Rows (also referred to as records) represent instances of an entity (e.g. specific employees). Generally, the ordering of columns is immaterial however identical rows are not allowed in a table. Each row has a single (separate) value for each of its columns. If the same value occurs in two different records (from the same table or different tables) it can imply a relationship between those records.

Tables can have a designated column or set of columns that act as a “key” to select rows from that table with the same or similar key values. A “primary key” is a key that has a unique value for each row in the table. Keys are commonly used to join or combine data from two or more tables. For example, an employee table may contain a column named address which contains a value that matches the key of an address table. Keys are also important in the creation of indexes, which facilitate fast retrieval of data from large tables. It is not necessary to define all the keys in advance; a column can be used as a key even if it was not originally intended to be one.

It is noted that components associated with the system 100 can include various computer or network components such as servers, clients, programmable logic controllers (PLCs), communications modules, mobile computers, wireless components, control components and so forth which are capable of interacting across a network. Similarly, the term PLC as used herein can include functionality that can be shared across multiple components, systems, and/or networks. For example, one or more PLCs can communicate and cooperate with various network devices across the network. This can include substantially any type of control, communications module, computer, I/O device, sensor, Human Machine Interface (HMI)) that communicate via the network which includes control, automation, and/or public networks. The PLC can also communicate to and control various other devices such as Input/Output modules including Analog, Digital, Programmed/Intelligent I/O modules, other programmable controllers, communications modules, sensors, output devices, and the like. In another aspect, an interface for an industrial control system is provided. The interface includes means for converting input data (aggregator 140) in a connected data structure to a business processing system 120 that employs an unconnected data structure. The system also includes means for transforming output data (format component 150) from the business processing system 120 to the connected structure.

The network can include public networks such as the Internet, Intranets, and automation networks such as Common Industrial Protocol (CIP) networks including DeviceNet and ControlNet. Other networks include Ethernet, DH/DH+, Remote I/O, Fieldbus, Modbus, Profibus, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

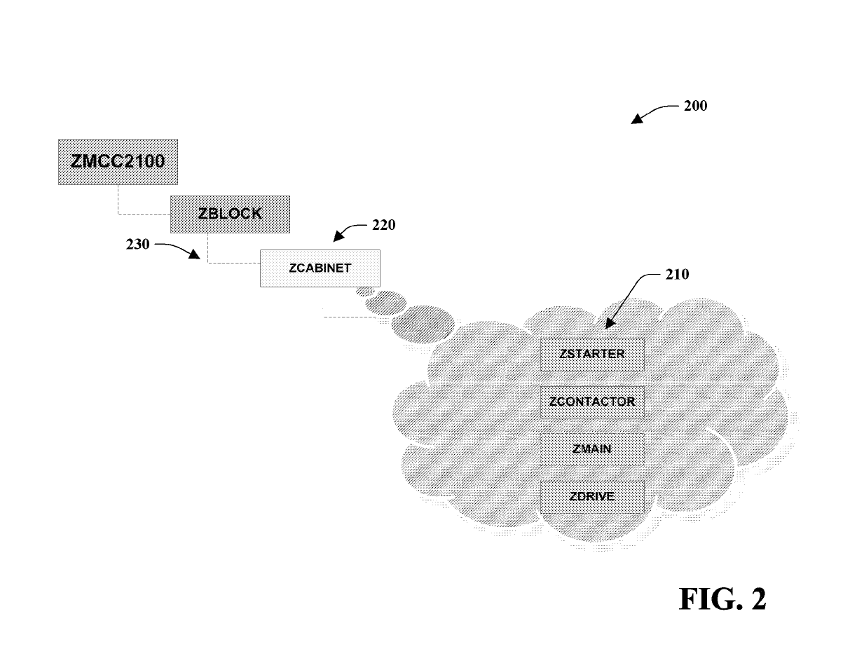

Turning to FIG. 2, a system 200 illustrates an example manufacturing model for an interface tool described above. While modeling a multi-level configured product model, the relationships employed in the VC (variant configurator) model were identified and specified at the cabinet level. For example, relationships as to where a unit 210 could be placed into a cabinet 220 were defined and held in a cabinet model. Then the characteristic information was defined using the unit configuration and transferred to the cabinet upon slotting of the unit. It is to be appreciated that other manufacturing structures than cabinets and units can be specified. The number of instances of the multi-level system architecture is now decided at the User Interface (UI) level after configuring individual components and “assembling” them based on predefined “slotting”/physical placement logic. This information along with the different attributes of the components is updated in the various “place holder” of the multilevel system model and is validated. Also, as the information to create a Sales Order BOM as per the manufacturing requirement is available at the User Interface Level, it is being processed and created from the user interface tool described above with respect to FIG. 1.

To illustrate how the various components process information in this example, the components illustrated at 210 have been isolated as individual components (no tree relationship), where such components are processed by the business processing system described above. As shown above the individual components 210, the user interface aspects allow the user to operate on component structures as members of a tree or other hierarchy. Example tree connections of a BOM structure are illustrated at 230. Thus, the user interface allows users to operate in one format (tree structure) while exchanging data in a subsequent format (individual component structure) required of the business processing system. As can be appreciated, other transforms are possible via the user interface component, aggregators, and formatters described above.

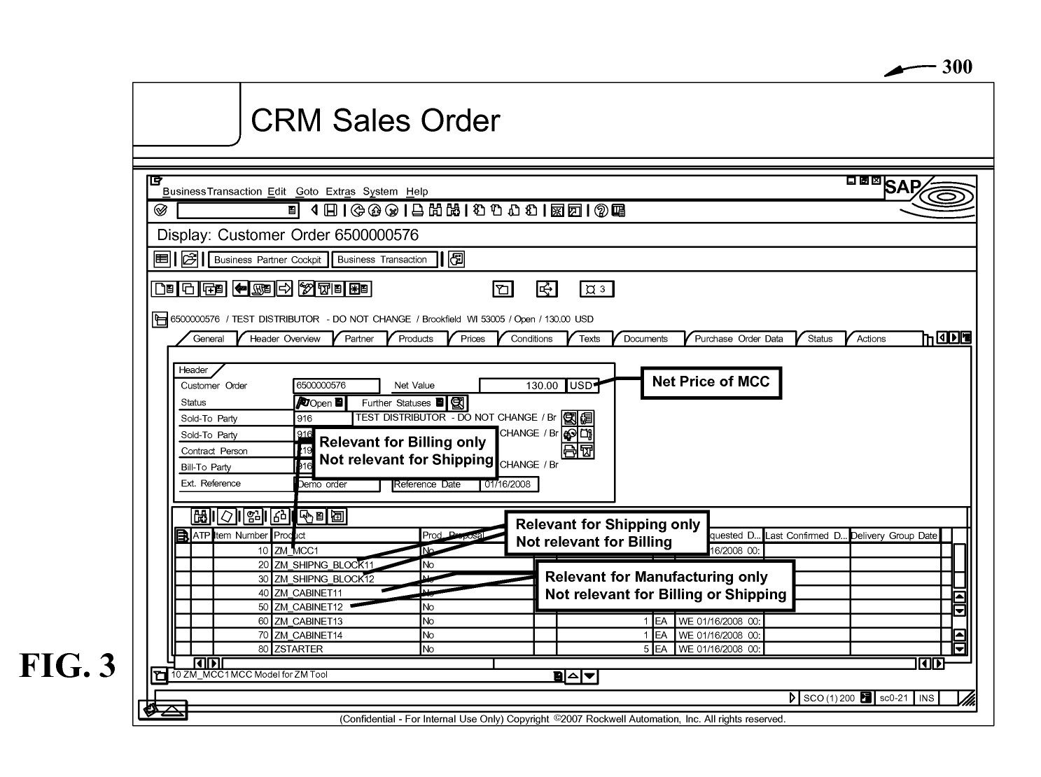

Referring now to FIG. 3, an example interface screen 300 is illustrated. In this aspect, a sales order screen 300 is illustrated where the screen acts as a buffer between the user and the business processing system. An advantage of the interface solution described herein is that it uses standard modeling techniques which have been constructed from the earlier component offerings and thus removes the on-going dependency on the SAP's custom development group. This helps in saving substantial amount of money in development and maintenance of the custom solution at the SAP end. It avoids the core modifications to the SAP system required to integrate the Advanced Mode functionality with other parts of the ERP system. Although there will be a development cost associated with the one time development of the User Interface, this cost can be controlled internally using current resources. Requirements for using SAP for ongoing maintenance and support will be mitigated and not be employed for testing during upgrades. This alternate solution also eliminates the need for the development of a new competency in Advanced Mode modeling. In addition, SAP does not officially support Advanced Mode as standard functionality. There are only a few companies worldwide that have tried to utilize Advanced Mode modeling. Another advantage to the user interface transform solution is avoiding replication of code for relationship logic in offline UI application and in SAP.

It is to be appreciated that the screen 300 is but one example of an interface employed to transform data with a business processing system. This can include a Graphical User Interface (GUI) to interact with the user or other components such as any type of application that sends, retrieves, processes, and/or manipulates data, receives, displays, formats, and/or communicates data, and/or facilitates operation of the system. For example, such interfaces can also be associated with an engine, server, client, editor tool or web browser although other type applications can be utilized.

The GUI or tool can include the display having one or more display objects (not shown) for manipulating the renderings including such aspects as configurable icons, buttons, sliders, input boxes, selection options, menus, tabs and so forth having multiple configurable dimensions, shapes, colors, text, data and sounds to facilitate operations with the tool. In addition, the GUI or tool can also include a plurality of other inputs or controls for adjusting, manipulating, and configuring one or more aspects. This can include receiving user commands from a mouse, keyboard, speech input, web site, remote web service and/or other device such as a camera or video input to affect or modify operations of the GUI.

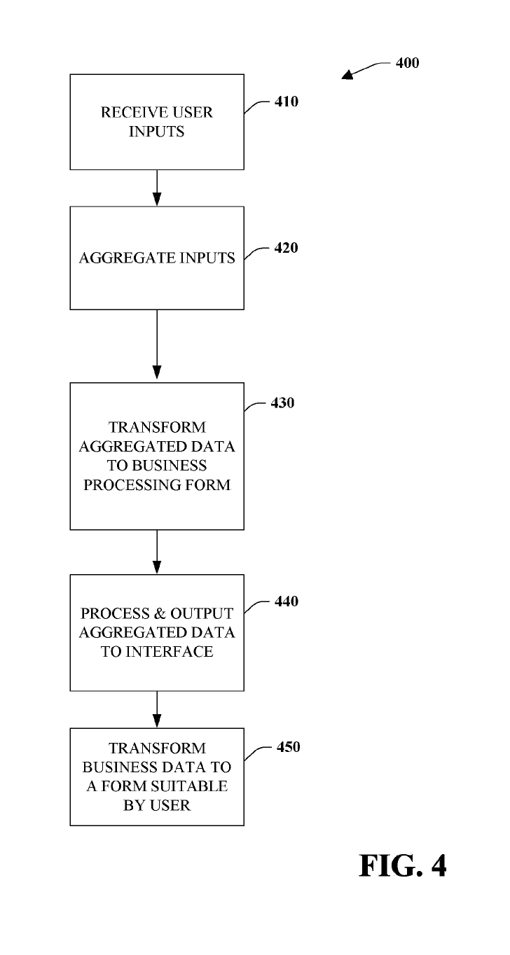

FIG. 4 is a flow diagram illustrating an interface transform process 400. While, for purposes of simplicity of explanation, the methodology is shown and described as a series of acts, it is to be understood and appreciated that the methodologies are not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as described herein.

Proceeding to 410, user inputs directing manufacturing instructions to a business processing system are received. At 420, the received inputs are aggregated at the interface. Such inputs could include bill of material requirements for an assembly or sub-assembly for example, where such requirements are represented in a connected or hierarchical form. At 430, the data that has been aggregated is transformed to a form that is understood by the business processing system (e.g., individual component form not connected by tree structure). Such systems can include SAP systems, ERP systems, MES systems, and manufacturing database systems for example. At 440, the transformed data that has been submitted to the business processing system is processed and output back to the interface. At 450, the interface transforms and formats the data in a form suitable for the user. Using the interface example depicted above in FIG. 3, a user may submit a sales order to the business processing system. After computations have been made on the sales order data, the business processing system outputs the computations to the interface. The interface in turn employs the returned data from the business system and transforms it in a manner suitable for display in the interface depicted in FIG. 3. As previously noted, a plurality of other types of interfaces screens can be provided.

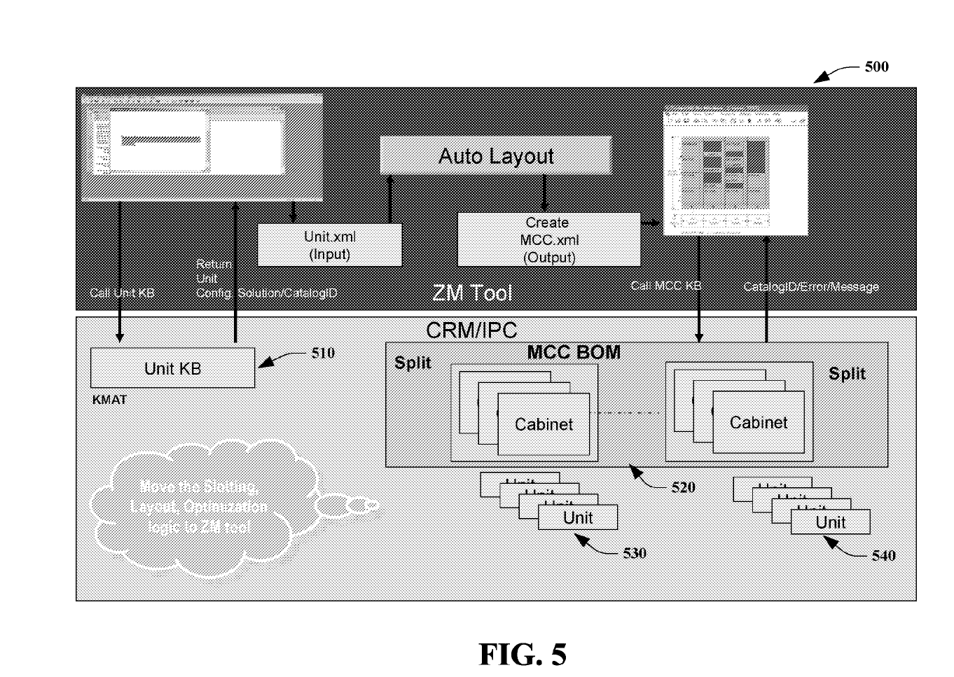

FIG. 5 is an example interface 500 for an industrial manufacturing system illustrating automatic layout features. In this aspect, units 510 can be created on a workspace. As shown, a control center BOM 520 is specified where two cabinets are defined for a particular control solution. Shown hierarchically under each cabinet are units at 530 and 540 respectively. As can be appreciated other structures than cabinets can be defined as well as other components than modules called out per the higher level members of the hierarchy.

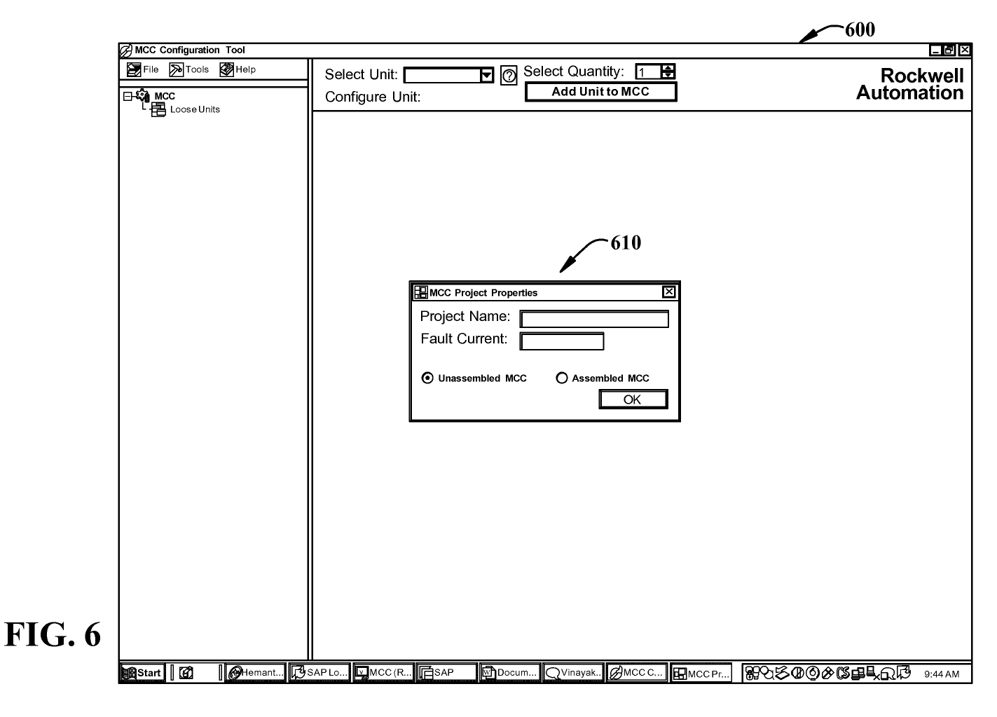

FIG. 6 is an example interface 600 for an industrial manufacturing system illustrating a project interface. An example property interface 610 is shown where a control cabinet project name can be defined. Fault current can be defined for the respective cabinet as well as features for designating the cabinet to be assembled or unassembled upon order of the respective cabinet.

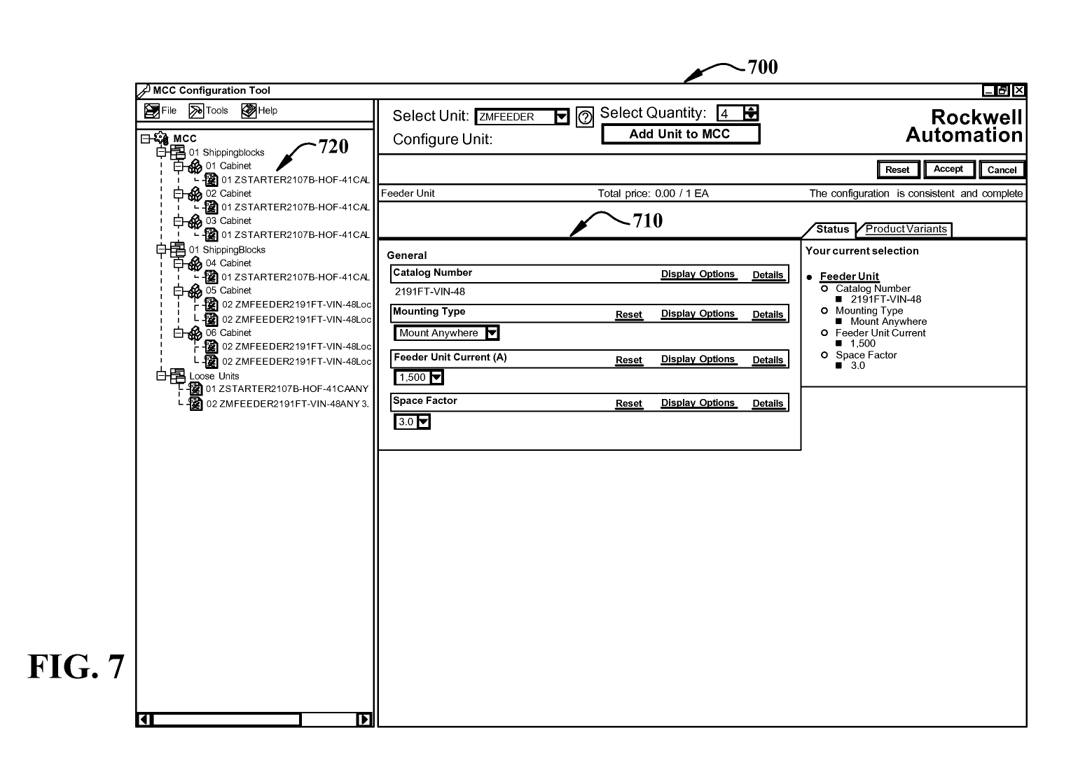

FIG. 7 is an example interface 700 for an industrial manufacturing system illustrating a unit specification interface. In this aspect, features of a module can be specified at 710. This includes catalog numbers, mounting types, unit current, mounting space or other dimensions, and so forth. As shown, a tree structure of cabinets and modules is illustrated at 720.

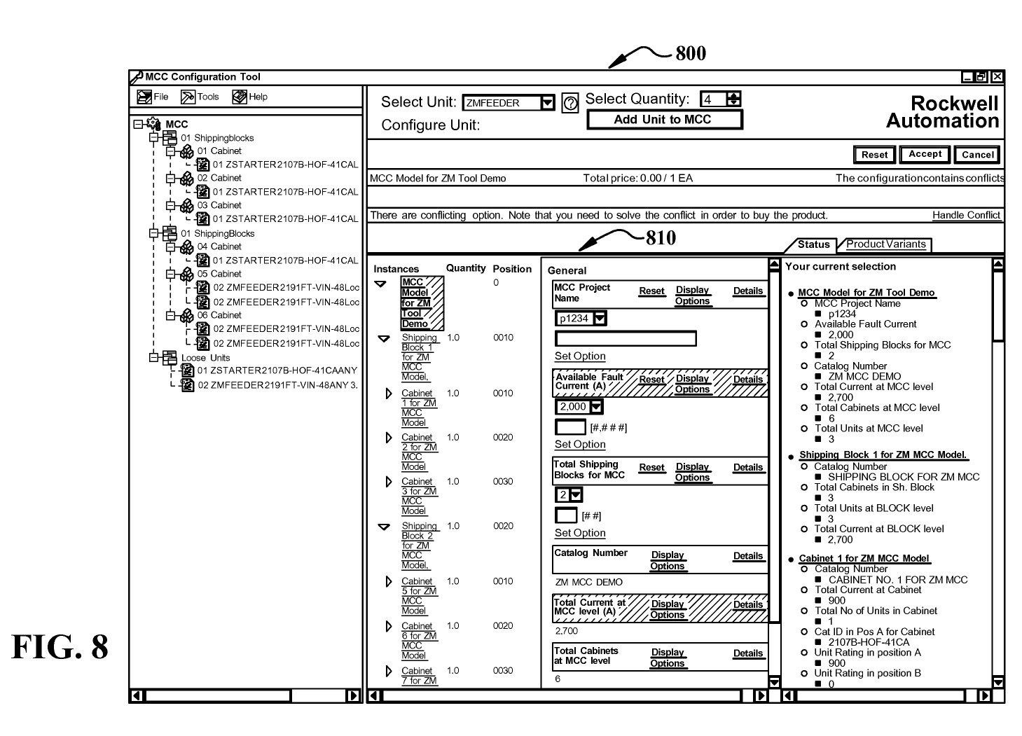

FIG. 8 is an example interface 800 for an industrial manufacturing system illustrating a module specification interface. In this example, module features can be specified at 810. Such features include catalog numbers, module current, number of shipping blocks and so forth.

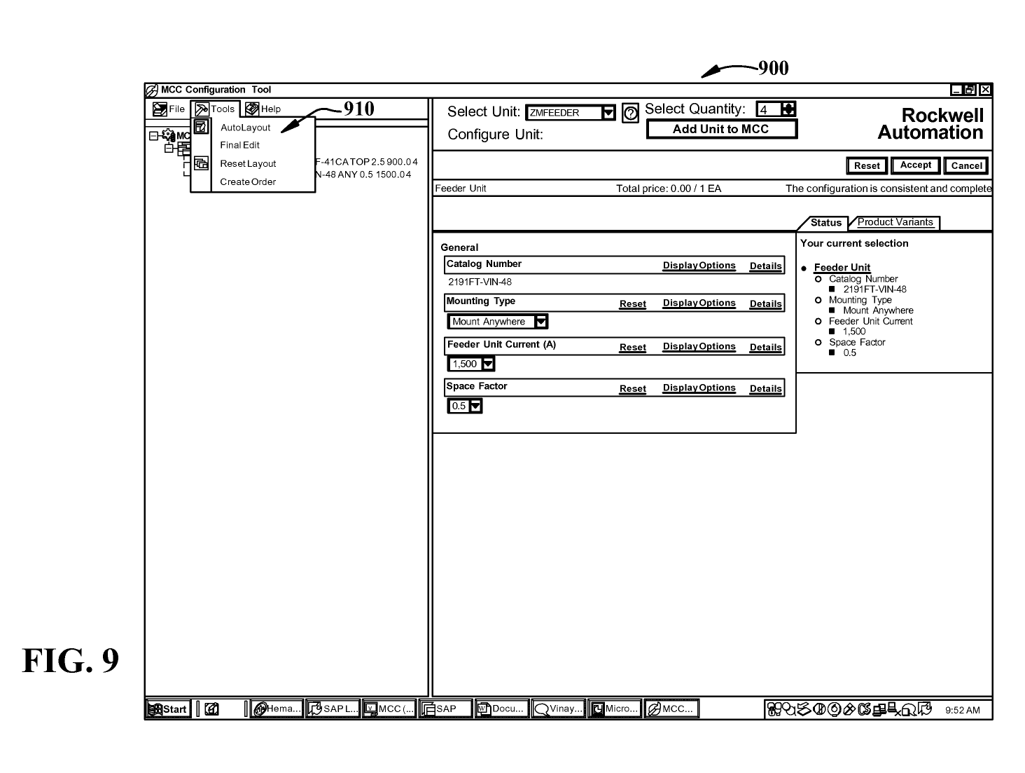

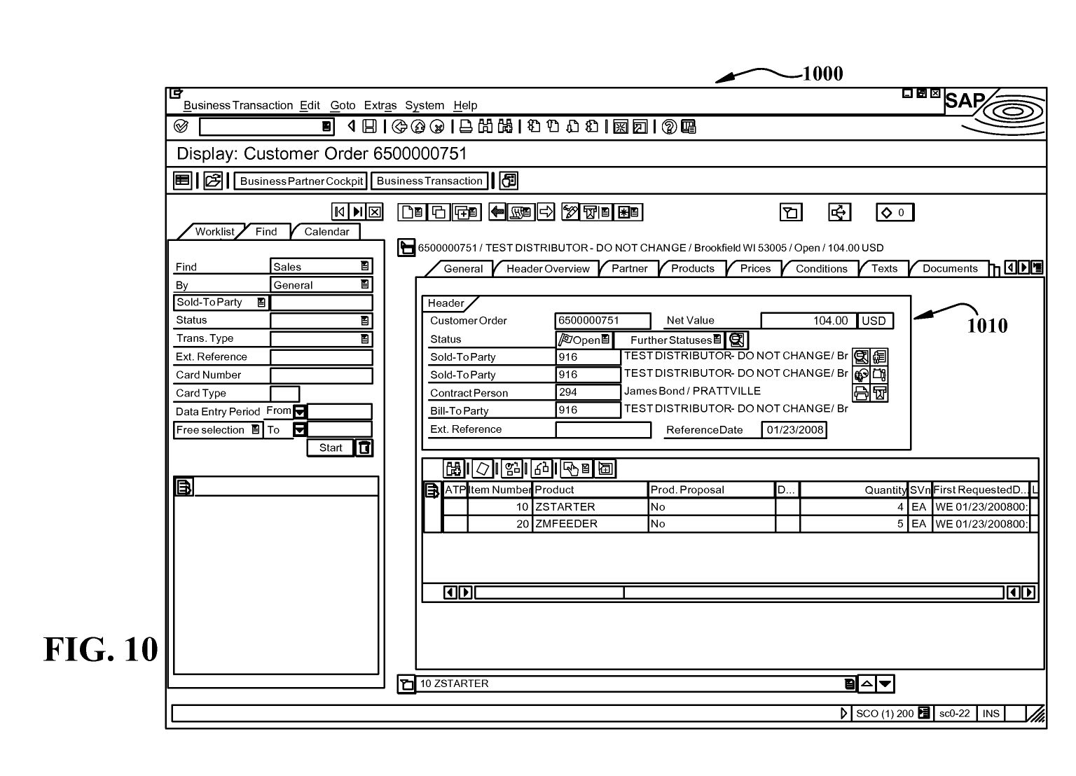

FIG. 9 is an example interface 900 for an industrial manufacturing system illustrating tools options. A tolls option selection is shown at 910. When this menu item is highlighted, auto layout feature menus can be selected, final edit features can be selected, reset layouts can be selected, and an option to create an order can be selected. Upon creating an order, an interface such as shown in FIG. 10 can be displayed.

FIG. 10 is an example interface 1000 for an industrial manufacturing system illustrating a business interface screen. The interface 900 shows a customer order table 1010 showing which parties are to receive an order, who should be billed, and what they are to receive. The interface 1000 in this example is part of an SAP system that processes the data input from the interface screens shown in FIGS. 5-9, where such data is transformed before being processed by the SAP system. As noted above, a plurality if differing types of business processing systems can be employed.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An interface tool, comprising:
an aggregator that collects input data from a user and transforms the input data to a form suitable by a business processing system; and
a format component that receives output data from the business processing system and transforms the output data to a form suitable by a user.

2. The interface tool of claim 1, the business processing system Systems, Applications and Products in Data Processing (SAP).

3. The interface tool of claim 2, the SAP system is an Enterprise Resource Planning system.

4. The interface tool of claim 2, the SAP system is a Customer relationship management (CRM) system.

5. The interface tool of claim 2, the SAP system is a Product lifecycle management (PLM) system.

6. The interface tool of claim 2, the SAP system is a Supply chain management (SCM) system.

7. The interface tool of claim 2, the SAP system is a Supplier relationship management (SRM) system.

8. The interface tool of claim 1, the business processing system is an industrial database system.

9. The interface tool of claim 1, the business processing system is a Material Execution System or a Material Resource Planning system.

10. The interface tool of claim 1, further comprising a component to define a bill of materials for an industrial system.

11. The interface tool of claim 10, the BOM is defined in a hierarchical tree structure having one or more nodes, the one or more nodes optionally having one or more sub-nodes.

12. The interface tool of claim 11, the BOM is segmented into individual nodes when transformed to a data structure suitable for a business processing system.

13. The interface tool of claim 12, the business processing system further comprising an interface to generate a sales order.

14. The interface tool of claim 12, further comprising a graphical tool to layout industrial equipment and to define the BOM from the layout.

15. The interface tool of claim 12, further comprising a unit interface to define one or more aspects of an industrial unit or cabinet.

16. The interface tool of claim 12, further comprising a module interface to define one or more aspects of an industrial module.

17. The interface tool of claim 12, further comprising a tools interface that selects an auto layout feature, an edit feature, a rest layout feature, or a create order feature.

18. A method to interface to an industrial processing system, comprising:
transforming input data in a related form structure to a business processing system that applies an individual form structure; and
transforming output data from the business processing system to the related form structure desired by a user of the system.

19. The method of claim 18, the related form structure is a hierarchical bill of material structure.

20. An interface for an industrial control system, comprising:
means for converting input data in a connected data structure to a business processing system that employs an unconnected data structure; and
means for transforming output data from the business processing system to the connected data structure.
